(19) United States
(12) Patent Application Publication
(10) Pub. No.: US 2023/0266446 A1
(43) Pub. Date: Aug. 24, 2023

(54) OPTOELECTRONIC SENSOR FOR DETECTING AND DETERMINING THE DISTANCE OF OBJECTS AND TRIGGER CIRCUIT FOR SUCH A SENSOR

(71) Applicant: SICK AG, Waldkirch (DE)

(72) Inventors: Alexander BOHLI, Waldkrich (DE); Stephan KOLB, Waldkrich (DE); Klaus CLEMENS, Waldkrich (DE); Axel JAHN, Waldkrich (DE)

(21) Appl. No.: 18/111,239

(22) Filed: Feb. 17, 2023

(30) Foreign Application Priority Data
Feb. 18, 2022 (EP) 22157591.3

(51) Int. Cl. G01S 7/4865; G01S 7/4861; G01S 17/10

(52) U.S. Cl. CPC G01S 7/4865; G01S 7/4861; G01S 17/10

(57) ABSTRACT

An optoelectronic sensor for detecting and determining the distance of an object in a monitored area is specified with a light emitter having a light source for emitting light pulses, a light receiver for generating a received signal from a light pulse remitted by the object and with a control and evaluation unit, which is designed to control the light emitter and to determine a time-of-flight of the light and, from this, a distance of the object to the sensor. The control and evaluation unit has a time measurement unit which is set up to receive the received signal and a trigger signal and to determine the time-of-flight of the light from a time interval between the trigger signal and the received signal. The sensor further has a trigger circuit that is set up to tap a voltage applied to the light source of the light emitter and to output the trigger signal when an amount of the tapped voltage exceeds a predetermined threshold value.

The invention relates to an optoelectronic sensor for detecting and determining the distance of an object in a monitoring area, having a light emitter which has a light source and is intended for emitting at least one light pulse, having a light receiver for generating a received signal from the light pulse which is remitted or reflected by the object, and having a control and evaluation unit which is designed to control the light emitter and to determine a time-of-flight of the light and, from this, to determine a distance of the object from the sensor, the control and evaluation unit having a timing unit which is set up to receive the received signal and a trigger signal and to determine the time-of-flight of the light from a time interval between the trigger signal and the receive signal, for detecting and determining the distance of objects in a monitored area. The invention further relates to a trigger circuit for generating a trigger signal for starting a time-of-flight measurement in such an optoelectronic sensor.

A well-known method for optical distance measurement is time-of-flight measurement. A distinction is made between pulse-based and phase-based measurement. In a pulse time-of-flight method, light beams with short light pulses are emitted by a light source, e.g. a laser diode, the returning light pulses are received by an optical receiver element, e.g. a single photon avalanche diode (SPAD), and the time until the reception of the returning light pulses is measured. Alternatively, in a phase method, emitted light is amplitude modulated and a phase shift between emitted and received light is determined, where the phase shift is also a measure of the time-of-flight of the light. The time-of-flight of the light is then converted into a distance via the speed of light. Optoelectronic sensors that use this method are often referred to as light scanners, TOF (Time-of-Flight) sensors or LIDAR (Light Detection And Ranging) sensors. To extend the measuring range, the light beam can be moved, as is done in a laser scanner. There, a light beam generated by a laser periodically sweeps the monitoring area with the help of a deflection unit. In addition to the measured distance information, the angular position of the deflection unit is used to infer the angular position of the object, and thus the location of an object in the monitoring area is recorded in two-dimensional polar coordinates. In most laser scanners, the scanning movement is achieved by a rotating mirror. However, it is also known to rotate the entire measuring head with light emitters and light receivers instead

The accuracy of the distance determination is directly dependent on the accuracy of the determination of the light travel time. It therefore requires the most precise knowledge possible of an emitting time at which a light pulse leaves the light source of the sensor and a reception time at which the returning light pulse hits the receiving element.

It is known from the prior art to send a signal to the light source which activates the light source to emit at least one light pulse, usually by sending a current or voltage pulse to the light source. This signal, hereinafter also referred to as activation signal, simultaneously starts a time-of-flight measurement. The time-of-flight measurement is stopped by a reception signal which the optical receiving element generates when it receives the returning light pulse. The activation signal and the reception signal are usually transmitted to a so-called time-to-digital converter (TDC), which determines the measurement of the time between the emission of the trigger signal and the generation of the reception signal. Details on TDCs can be found, for example, in Henzler, Stephan. “Time-to-digital converters.” Vol. 29. Springer Science & Business Media, 2010 or the Annual Report 2015 of the Circuits and Systems Group of the University of Oulu by J. Kostamovaara and T. Rahkonen.

Since the emission of the current or voltage pulse to the light source and thus the emission of the light pulse usually occurs with a latency after the emission of the activation signal, a calibration must first be carried out by light travel time measurements on objects with known distances. However, for example, temperature drift, ageing or fluctuation (jitter) of electronic components between the trigger source and the light source as well as the light source itself can influence the time duration between the emission of the activation signal and the emission of a current or voltage pulse to the light source and thus the emission of the light pulse and therefore affect the accuracy of the distance measurement.

To improve the accuracy of the distance measurement, it is also known to detect the emission of the light pulse by a light receiver, e.g. a photodiode, immediately downstream of the light source, and to start the time-of-flight measurement when the light pulse is detected. Such an arrangement almost completely eliminates the negative influences on the time-of-flight measurement described above, but it is disadvantageous that the arrangement is complex and, in particular, additional optical components with corresponding installation space requirements and adjustment effort are needed.

In the European patent application EP 3 521 856 A1, it is proposed to provide a calibration path in addition to a measurement path for time-of-flight measurement in order to improve the accuracy of the time-of-flight determination. The calibration path can be set up in particular to measure a laser current of a laser light source. The laser current is compared by means of a comparator with a threshold value which, when exceeded, usually results in the emission of laser radiation. By determining the time period between activation of the light source and exceeding the threshold value of the laser current, the latency between activation of the light source and emission of the light pulse can be determined and taken into account in the runtime calculation. Since the disclosed circuit uses a calibration path in addition to a measurement path, it is correspondingly complex. A direct use of the threshold crossing of the laser current to start the light runtime measurement is not disclosed.

Based on this prior art, it is the object of the invention to provide an improved optoelectronic sensor for determining the time-of-flight of light.

This object is solved by an optoelectronic sensor for detecting and determining the distance of objects in a monitored area with the following features.

An optoelectronic sensor according to the invention has at least one light emitter with at least one light source for emitting light pulses into a monitoring area. An associated light receiver is capable of generating reception signals from light pulses reflected or remitted by objects in the monitoring area. A control and evaluation unit controls the light emitter and the light receiver and can evaluate the light receiver's reception signals to obtain information about the object, such as a distance to the sensor. To determine the distance between the object and the sensor, the control and evaluation unit has a time measurement unit, for example a time-to-digital converter (TDC). The time measurement unit is set up to determine a time-of-flight of light pulse from a time interval between a trigger signal and a received signal of the light receiver. The trigger signal is generated by a trigger circuit that taps a voltage applied to the light source of the light emitter and emits the trigger signal when a magnitude of the tapped voltage exceeds a predetermined threshold value. The exceeding of the threshold value is directly related to the emission of a light pulse by the light source. This reduces the influence on the measurement of the light propagation time of latencies that occur between the emission of an activation signal by the control and evaluation unit to the light emitter and the emission of a current or voltage pulse to the light source and thus the emission of the light pulse by the light source.

The light emitter may have a light source driver to supply power to the light source. This allows the voltage and current required by the light source to be adjusted to the light source and protects the light source from damage. The light source may preferably be a laser diode or a light emitting diode.

The object of the invention is also solved by a a trigger circuit for such a sensor. The trigger circuit can have a voltage divider for tapping the voltage applied to the light source of the light emitter. By suitably dimensioning the voltage divider, the load on the electronics of the light source driver and/or the light source can be reduced on the one hand, and on the other hand, a part of the tapped voltage suitable for subsequent evaluation electronics of the trigger circuit can be provided.

The voltage tap can preferably be made at a cathode of the light source. This has the advantage that the tapped voltage essentially represents the current through the light source. This ensures that all latencies of the components involved in providing the current for the light source, in particular their thermal dependence, can be taken into account.

In one embodiment, the evaluation electronics of the trigger circuit can have a comparator for further processing of the tapped voltage or the voltage provided by the voltage divider, which provides an output signal as a trigger signal for the time measurement unit. The comparator is preferably a comparator with differential outputs, whereby a short processing time and fast rise and fall times of the output signal can be achieved. To convert a differential output signal of the comparator into a unipolar output signal, a signal converter can be arranged downstream of the comparator.

In a preferred embodiment, the trigger circuit for further processing of the tapped voltage or the voltage provided by the voltage divider can have a monostable flip-flop, whereby the voltage tapped at the light source or the voltage provided by the voltage divider serves as the input signal for the monostable flip-flop and the trigger signal for the time measurement unit is generated on the basis of an output signal of the monostable flip-flop.

The monostable flip-flop has a first and a second transistor, whereby the voltage tapped at the light source or the voltage provided by the voltage divider can preferably be applied to the base of the first transistor as the input signal of the monostable flip-flop. The collector voltage of the first transistor forms the output signal of the monostable flip-flop as a trigger signal for the timing unit. The first transistor of the flip-flop can be brought from the conducting state to the blocked state without DC voltage by the input signal. This makes the second transistor conductive and makes it possible to set a hold time of the monostable flip-flop, i.e. the output signal of the monostable flip-flop.

The collector-base path of the first transistor may comprise a series circuit comprising a first diode and a damping resistor. This can prevent saturation of the first transistor in the conductive state, enabling fast blocking of the first transistor. Furthermore, a voltage feedback takes place through the first diode, which counteracts a temperature response of the first transistor. This leads to a working point stabilisation of the first transistor.

The base-emitter path of the first transistor can have a second diode. This can protect the base-emitter path of the first transistor from harmful negative voltages.

The collector voltage of the first transistor can preferably be AC-coupled in such a way that a residual voltage present between the collector and the emitter due to the lack of saturation of the first transistor can be compensated for in the idle state of the monostable flip-flop, i.e. when a magnitude of the voltage present at the light source of the light emitter does not exceed a predetermined threshold value. Thus, the output signal of the monostable flip-flop has a voltage of 0 volts in the idle state of the monostable flip-flop.

In the following, the invention is explained in detail by means of an example of an embodiment with reference to the drawing. The drawing shows:

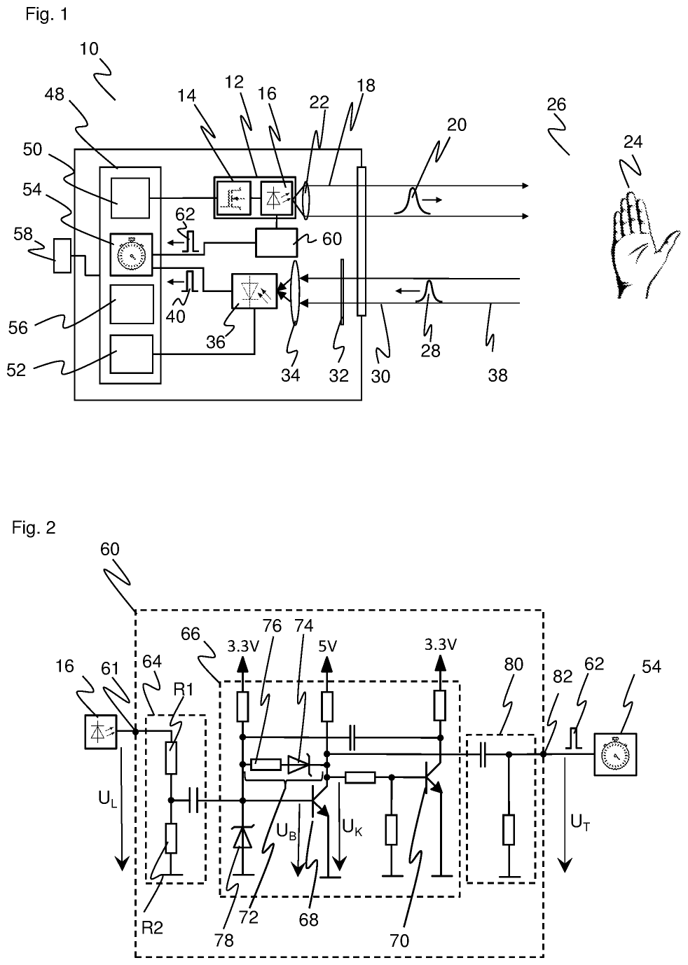

FIG. 1 a schematic representation of an optoelectronic sensor according to the invention;

FIG. 2 a schematic example of a trigger circuit of an optoelectronic sensor according to the invention;

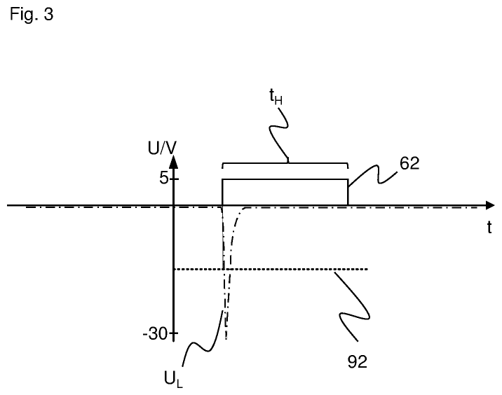

FIG. 3 an exemplary signal curve of a voltage tapped at a light source of the sensor and a trigger signal

FIG. 1 shows a schematic representation of an optoelectronic sensor 10 according to the invention. The sensor 10 has a light emitter 12 which comprises a light source driver 14 and a light source 16, for example a laser diode or a vertical-cavity surface-emitting laser (VCSEL). The light source 16 emits a measuring light beam 18 with at least one light pulse 20. A collimation optics 22 for collimating the measuring light beam 18 is arranged downstream of the light source 16 in the light beam direction. The collimation optics 22 is shown here purely as an example as a biconvex lens, but can have a more complex structure, for example be designed as a lens having several lenses.

The at least one light pulse 28 reflected or remitted at an object 24 in the monitoring area 26 is guided as a received light beam 30 via an (optional) optical filter 32 for suppressing interfering light and a receiving optical system 34 to a light receiver 36, which generates received signals 40 when receiving the reflected or remitted light pulses 28.

The light receiver 36 is preferably a photodiode, APD (Avalanche Photo Diode), or SPAD (Single-Photon Avalanche Diode), or SPAD array.

A control and evaluation unit 48 is further provided in the sensor 10, which is connected to the light emitter 12, and the light receiver 36. The control and evaluation unit 48 comprises a light emitter control 50, light receiver control 52, a time measurement unit 54, for example a time-to-digital converter (TDC), and an object distance estimation unit 56, whereby these are initially only functional blocks which can also be implemented in the same hardware or in other functional units such as in the light emitter control 50, the light receiver control 52, or in the light receiver 46. Via an interface 58, the control and evaluation unit 48 can output measurement data or, conversely, receive control and parameterisation instructions. The control and evaluation unit 48 can also be arranged in the form of local evaluation structures on a chip of the light receiver 46, or it can interact as a partial implementation with the functions of a central evaluation unit (not shown).

The sensor 10 further comprises a trigger circuit 60. The trigger circuit 60 is also shown as a functional block and may be implemented as separate hardware or in other functional units of the sensor 10. The trigger circuit 60 taps a voltage applied to the light source 16 of the light emitter 12 and outputs a trigger signal 62 to the timing unit 54 when a magnitude of the tapped voltage exceeds a predetermined threshold, the exceeding of the threshold representing an output of a light pulse 20 by the light source 16. The trigger signal 62 starts a time-of-flight measurement of the timing unit 54. The emitted light pulse 20 is reflected or remitted by the object 24 in the monitoring area 26, and the light receiver 36 generates a receive signal 40 upon detection of the reflected or remitted light pulse 28. The received signal 40 is transmitted to the timing unit 54, which stops the light transit time measurement, determines a time interval between the trigger signal 62 and the received signal 40, and determines a light transit time of the light pulse therefrom. The light travel time is transmitted to the object distance estimation unit 54, which determines a distance of the object 24 to the sensor based on the time-of-flight of the light.

FIG. 2 shows a schematic embodiment of a trigger circuit 60 of the sensor 10 according to the invention. A voltage U_{L} applied to the light source 16 of the sensor 10 is tapped at the circuit input 61 of the trigger circuit 60 by a voltage divider 64. A suitable dimensioning of the voltage divider 64 minimises a feedback effect of the voltage measurement on the current flowing through the light source 16. The voltage divider 64 has a first resistor R1 and a second resistor R2, the resistance ratio of which is selected in such a way that the voltage applied to the resistor R2 lies in a range permissible for a monostable flip-flop 66 connected downstream of the voltage divider 64. The voltage applied to resistor R2 serves as an input signal for the monostable flip-flop 66 and is applied there as a base voltage UB to a first transistor 68. The first transistor 68 is controlled by this base voltage. The first transistor 68 is brought from a conducting to a blocked state by this input signal without DC voltage, whereby a second transistor 70 becomes conducting by blocking the first transistor 68. The collector voltage UK applied to the first transistor 68 forms the output signal of the monostable flip-flop 66 and serves as the basis of the trigger signal 62 for the timing unit 54.

The base-collector path 72 of the first transistor 68 has a first diode 74 in series with a damping resistor 76. This prevents saturation of the first transistor 68 when a magnitude of the voltage U_{L} applied to the light source 16 of the sensor 10 does not exceed a predetermined threshold, thereby enabling rapid disabling of the first transistor 68. Furthermore, a voltage negative feedback is provided by the first diode 74, which counteracts a temperature response of the first transistor 68 and contributes to the operating point stabilisation of the first transistor 68. The temperature response of the second transistor 70 is negligible due to its operation in saturation. The hold time and amplitude of the output signal of the monostable flip-flop 66 are adjustable within the limits of what is customary in the art. The base-emitter path of the first transistor 68 is protected from harmful negative voltages by a second diode 78.

Because of the prevention of saturation of the first transistor 68, the output signal of the monostable flip-flop 66 cannot become 0 volts in the idle state of the monostable flip-flop 66, that is, when a magnitude of the voltage U_{L} applied to the light source 16 does not exceed a predetermined threshold, but has a residual voltage. Therefore, an AC coupling 80 is connected downstream of the output of the monostable flip-flop 66 so that the trigger signal 62 at the circuit output 82 of the trigger circuit 60 has a voltage U_{T} of 0 volts in the idle state. In order to achieve a sufficient voltage amplitude of the trigger signal 62, the collector branch of the first transistor must be supplied with a higher voltage than is required as signal amplitude by the downstream electronics, in particular the timing unit 54. A minimum operating voltage of the collector branch of the first transistor 68 results from the collector-emitter voltage of the first transistor 68 in the idle state and the minimum voltage required by the subsequent electronics, so that the collector branch of the first transistor 66 may have to be supplied with a higher voltage than required by the subsequent electronics.

FIG. 3 shows an exemplary time curve of the voltage U_{L} (represented by a dotted line) tapped at the light source 16 of the sensor and of the trigger signal 62 (represented by a solid line) generated by the trigger circuit 60 at the output of the trigger circuit 60. When the magnitude of the voltage U_{L} applied to the light source 16 exceeds a predetermined threshold 92, the first transistor 68 of the monostable trigger circuit 60 turns off. The voltage signal at the input of the monostable trigger circuit 60 has a time length of less than one nanosecond. The voltage UK applied to the collector of the first transistor 68 forms the basis for the trigger signal 62 output by the trigger circuit 60. The leading edge of the trigger signal 62 corresponds in time essentially, i.e. within the scope of the switching speed of the monostable flip-flop 60, to the falling edge of the voltage U_{L} tapped at the light source 16 of the sensor 10. The hold time t_{H} of the trigger signal 62 significantly exceeds the duration of the voltage signal at the input of the monostable flip-flop 60 in accordance with the requirements of the timing unit 54. The voltage rise of the trigger signal 62 is strictly monotonic and its amplitude exceeds a detection threshold of the timing unit 54 for the entire hold time t_{H} of the trigger signal 62.

1. Optoelectronic sensor (10) for detecting and determining the distance of an object (24) in a monitoring area (26), having a light emitter (12) which has a light source (16) and is intended for emitting at least one light pulse (20), having a light receiver (36) for generating a received signal (40) from the light pulse (28) which is remitted or reflected by the object (24), and having a control and evaluation unit (48) which is designed to control the light emitter (12) and to determine a time-of-flight of the light and, from this, to determine a distance of the object (24) from the sensor (10), the control and evaluation unit (48) having a timing unit (54) which is set up to receive the received signal (40) and a trigger signal (62) and to determine the time-of-flight of the light from a time interval between the trigger signal (62) and the receive signal (40),
characterised in that the sensor (10) has a trigger circuit (60) which is set up to pick up a voltage (U_{L}) applied to the light source (16) of the light emitter (12) and to output the trigger signal (62) when a magnitude of the picked-up voltage (U_{L}) exceeds a predetermined threshold value (92).

2. The sensor (10) of claim 1, wherein the light emitter (12) comprises a light source driver (14) for supplying power to the light source (16).

3. Sensor (10) according to claim 1, wherein the trigger circuit comprises a voltage divider (64) for picking up the voltage (U_{L}) applied to the light source (16) of the light emitter (12).

4. Sensor (10) according to claim 1, wherein the voltage (U_{L}) applied to the light source (16) of the light emitter (12) is picked up at a cathode of the light source (16).

5. Sensor (10) according to claim 1, wherein the trigger circuit (60) comprises a comparator for generating the trigger signal (62).

6. The sensor (10) of claim 1, wherein the trigger circuit (60) comprises a monostable flip-flop (66) for generating the trigger signal (62).

7. The sensor (10) of claim 6, wherein the monostable flip-flop (66) is arranged to transfer a first transistor (68) of the monostable flip-flop (66) from a conductive state to a blocking state when the magnitude of the voltage (U_{L}) applied to the light source (16) of the light emitter (12) exceeds a predetermined threshold.

8. The sensor (10) of claim 7, wherein the trigger circuit (60) is arranged to generate the trigger signal (62) based on a collector voltage (UK) of the first transistor (68).

9. The sensor (10) of claim 7, wherein a base-collector path (72) of the first transistor (68) comprises a series connection with a first diode (74) and a damping resistor (76) for preventing saturation of the first transistor (68).

10. A sensor (10) according to claim 7, wherein a base-emitter path of the first transistor (68) comprises a second diode (78) for protecting the base-emitter path from negative voltages.

11. A sensor (10) according to claim 6, wherein an AC coupling (80) is arranged downstream of the monostable flip-flop (66).

12. Trigger circuit (60) for generating a trigger signal (62) for starting a time-of-flight measurement in an optoelectronic sensor (10) according to claim 1, comprising
a circuit input (61) for picking up a voltage (U_{L}) applied to the light source (16) of the sensor (10),
a monostable flip-flop (66), the monostable flip-flop (66) being arranged to generate the trigger signal (62) on the basis of the voltage (U_{L}) applied to the light source (16) of the sensor (10),
a circuit output (82) for providing the trigger signal (62).

13. A trigger circuit (60) according to claim 12, wherein the trigger circuit (60) comprises a voltage divider (64).

14. A trigger circuit (60) according to claim 12, wherein the monostable flip-flop (66) is arranged to transfer a first transistor (68) of the mono stable flip-flop (66) from a conducting state to a blocking state when a magnitude of the voltage (U_{L}) applied to the light source (16) of the sensor (10) exceeds a predetermined threshold.

15. The trigger circuit (60) of claim 14, wherein a base-collector path (72) of the first transistor (68) comprises a series connection with a first diode (74) and a damping resistor (76) for preventing saturation of the first transistor (68) in the conducting state.
